(19) United States
(12) Patent Application Publication
(10) Pub. No.: US 2025/0189372 A1
(43) Pub. Date: Jun. 12, 2025

(54) INTERFERENCE STRUCTURE, DETECTION APPARATUS, AND SPECTROMETER

(71) Applicant: Shanghai Institute of Technical Physics, Chinese Academy of Sciences, Shanghai (CN)

(72) Inventors: Shaowei WANG, Shanghai (CN); Qingquan LIU, Shanghai (CN); Yunpeng LI, Shanghai (CN); Wei LU, Shanghai (CN)

(73) Assignee: Shanghai Institute of Technical Physics, Chinese Academy of Sciences, Shanghai (CN)

(21) Appl. No.: 19/052,568

(22) Filed: Feb. 13, 2025

Related U.S. Application Data
(63) Continuation of application No. PCT/CN2023/138062, filed on Dec. 12, 2023.

(30) Foreign Application Priority Data
Dec. 19, 2022 (CN) 202211634103.4

(51) Int. Cl. G01J 3/12; G01J 3/28

(52) U.S. Cl. CPC G01J 3/12; G01J 3/28; G01J 2003/1226

(57) ABSTRACT

Disclosed is an interference structure, including an interference film layer. The interference film layer includes a plurality of regions, where the plurality of regions includes a transparent region made of transparent material. In a direction perpendicular to the interference film layer, a thickness of at least one region in the plurality of regions is different from a thickness of a region other than the at least one region in the plurality of regions. In other words, in the present disclosure, by including the plurality of regions with different thicknesses in the interference film layer, it is possible to process the incident light into the plurality of beams of interference light corresponding to the incident light, without the need for multiple optical lenses in traditional interference structures. Therefore, the structure of the interference structure in the present disclosure is simple and easy to miniaturize.

### CROSS-REFERENCE TO RELATED APPLICATIONS

This application is a continuation of International Application No. PCT/CN2023/138062, filed on Dec. 12, 2023, which claims priority to Chinese Patent Application No. 202211634103.4, filed on Dec. 19, 2022. The disclosures of the aforementioned applications are hereby incorporated by reference in their entireties.

### TECHNICAL FIELD

The present disclosure relates to the field of spectral analysis technologies, and in particular, to an interference structure, a detection apparatus, and a spectrometer.

### BACKGROUND

A spectrometer is mainly applied in remote sensing (ground target detection of Unmanned Aerial Vehicle, environmental monitoring, crop monitoring, etc.), fire safety, healthcare (fundus diseases, blood vessels, teeth, and cancer detection, etc.), and forensic identification (fingerprints, blood traces, physical evidence detection, etc.). In these fields, demand on physical size of the spectrometer is increasingly stringent. However, as for an interference structure of a traditional spectrometer, a beam of incident light is transformed into two beams of interference light through multiple optical lenses including a beam splitter, a phase compensation mirror, a moving mirror, a fixed mirror, and the like, so that the structure of the spectrometer is complex and miniaturization of the spectrometer is difficult.

### SUMMARY

In view of this, embodiments of the present disclosure provide an interference structure, a detection apparatus, and a spectrometer, to solve a problem of complexity in structure and difficulty in miniaturization for a traditional Fourier spectrometer.

In a first aspect, an embodiment of the present provides an interference structure, applied to a spectrometer, where the interference structure is configured to receive incident light and output a plurality of beams of interference light corresponding to the incident light. The interference structure includes: an interference film layer including a plurality of regions, where the plurality of regions includes a transparent region made of transparent material. In a direction perpendicular to the interference film layer, a thickness of at least one region in the plurality of regions is different from a thickness of a region other than the at least one region in the plurality of regions. As for an interference structure of a traditional spectrometer, a beam of incident light is transformed into two beams of interference light through multiple optical lenses including a beam splitter, a phase compensation mirror, a moving mirror, a fixed mirror, and the like, so that the structure of the spectrometer is complex and miniaturization of the spectrometer is difficult. However, in the present disclosure, as the interference film layer includes the plurality of regions with different thicknesses, it is possible to transform the incident light into the plurality of beams of interference light corresponding to the incident light without multiple optical lenses in the traditional interference structure. Therefore, the structure of the interference structure provided by the present disclosure is simple and easy to miniaturize.

In a second aspect, an embodiment of the present provides a detection apparatus. The detection apparatus includes the interference structure according to the first aspect; and a detector stacked with the interference structure, configured to detect the plurality of beams of interference light output by the interference structure and generate spectral response data corresponding to the plurality of beams of interference light.

In a third aspect, an embodiment of the present provides a spectrometer. The spectrometer includes a detection apparatus according to the second aspect; a processor connected to the detection apparatus, configured to reconstruct the spectral response data to generate reconstructed spectral data.

The interference structure provided by the embodiments of the present disclosure is applied to a spectrometer, and the interference structure is configured to receive incident light and output a plurality of beams of interference light corresponding to the incident light. The interference structure includes: an interference film layer including a plurality of regions, where the plurality of regions includes a transparent region made of transparent material, and in a direction perpendicular to the interference film layer, a thickness of at least one region in the plurality of regions is different from a thickness of a region other than the at least one region in the plurality of regions. As for an interference structure of a traditional spectrometer, a beam of incident light is transformed into two beams of interference light through multiple optical lenses including a beam splitter, a phase compensation mirror, a moving mirror, a fixed mirror, and the like, so that the structure of the spectrometer is complex and miniaturization of the spectrometer is difficult. However, in the present disclosure, as the interference film layer includes the plurality of regions with different thicknesses, it is possible to transform the incident light into the plurality of beams of interference light corresponding to the incident light without multiple optical lenses in the traditional interference structure. Therefore, the structure of the interference structure provided by the present disclosure is simple and easy to miniaturize.

In addition, compared to the interference structure in the traditional spectrometer, the interference structure of the present disclosure does not include any moving part (such as a moving mirror). Thus, the interference structure of the present disclosure has better stability and higher reliability. The traditional spectrometer relies on the moving part to scan and obtain the plurality of beams of interference light, based on which target spectral information may be obtained. However, the spectrometer, including the interference structure of the present disclosure, can obtain the plurality of beams of interference light through arrangement of the plurality of regions on the interference film layer, without the need for scanning. Only one shot is needed to obtain the target spectral information, which improves spectral reconstruction efficiency of the spectrometer.

### BRIEF DESCRIPTION OF THE DRAWINGS

FIG. 1 illustrates a working principle of a Michelson interferometer.

FIG. 2 is a schematic diagram of an interference structure according to an embodiment of the present disclosure.

FIG. 3 is a schematic diagram of an interference structure according to another embodiment of the present disclosure.

FIG. 4 is a three-dimensional schematic diagram of an interference structure according to another embodiment of the present disclosure.

FIG. 5 is a side view of the interference structure shown in FIG. 4.

FIG. 6 is a schematic diagram of an interference structure according to another embodiment of the present disclosure.

FIG. 7 is a schematic diagram of an interference structure according to still another embodiment of the present disclosure.

FIG. 8 is a schematic diagram of an interference structure according to yet still another embodiment of the present disclosure.

FIG. 9 is a schematic diagram of an interference structure according to yet still another embodiment of the present disclosure.

FIG. 10 is a schematic diagram of a detection apparatus according to an embodiment of the present disclosure.

FIG. 11 is a schematic diagram of a detection apparatus according to another embodiment of the present disclosure.

FIG. 12 is a schematic diagram of a spectrometer according to an embodiment of the present disclosure.

FIG. 13 is a schematic diagram of a spectrometer according to another embodiment of the present disclosure.

FIG. 14 is a spectral response of a detector pixel.

FIG. 15 is a reconstructed spectrum obtained by detecting a signal with four peaks through an infrared thin-film interferometric chip-level spectrometer.

FIG. 16 is a reconstructed spectrum obtained by calibrating the resolution of an infrared thin-film interferometric chip-level spectrometer using bimodal narrow light.

### DETAILED DESCRIPTION OF THE EMBODIMENTS

A clear and complete description of the technical solutions in the embodiments of the present disclosure will be given with reference to the accompanying drawings. Obviously, the described embodiments are a part of the embodiments of this specification, and not all embodiments. Based on the embodiments of the present disclosure, all other embodiments obtained by those skilled in the art without creative efforts shall fall within the protection scope of the present disclosure.

A spectrometer is mainly applied in remote sensing (ground target detection of Unmanned Aerial Vehicle, environmental monitoring, crop monitoring, etc.), fire safety, healthcare (fundus diseases, blood vessels, teeth, and cancer detection, etc.), and forensic identification (fingerprints, blood traces, physical evidence detection, etc.). In these fields, demand on physical size of the spectrometer is increasingly stringent. Traditional spectrometers are generally Fourier spectrometers which are designed based on Fourier transform. The Fourier spectrometer is a spectral testing device, taking a Michelson interferometer as a core. The Fourier spectrometer is capable of extracting interference information from a target and using Fourier transform to convert an interference spectrum of the target into a spectrum. Although the Fourier spectrometer has advantages of high light throughput, strong noise resistance, and high testing accuracy, the Fourier spectrometer is very complex and has a large volume and high cost, which severely limits their application scenarios.

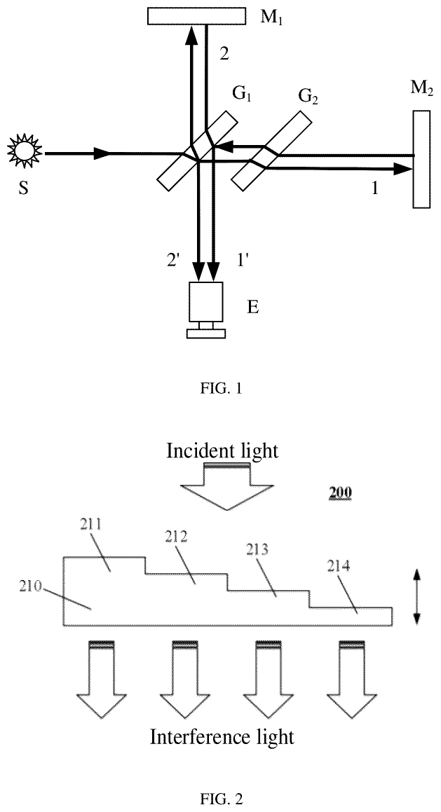

FIG. 1 illustrates a working principle of a Michelson interferometer. As shown in FIG. 1, the Michelson interferometer decomposes a beam of incident light emitted from a light source S into two beams of light through a beam splitter G1, a phase compensator G2, a moving mirror M1, and a fixed mirror M2. The two beams of light interfere before reaching a detector E, and are then received by the detector E. Specifically, the incident light emitted from the light source S, after reaching the beam splitter G1, is divided into two beams of light. A first light beam 1 passes through the beam splitter G1 and the phase compensator G2 to reach the fixed mirror M2 and is reflected by the fixed mirror M2. After being reflected by the fixed mirror M2, the first light beam 1 passes through the phase compensator G2 to reach the beam splitter G1 and is reflected by the beam splitter G1 to reach the detector E. A first interference light beam 1′ is formed. A second light beam 2 is reflected by the beam splitter G1 to reach the moving mirror M1 and is reflected by the moving mirror M1. After reflected by the moving mirror M1, the second light beam 2 passes through the beam splitter G1 to reach the detector E. A second interference light beam 2′ is formed. The first interference light beam 1′ and the second interference light beam 2′ interfere with each other and are received by the detector E. By changing a position of the moving mirror, a series of different interference values are obtained. After these interference values are subjected to Fourier transformation, a spectrum is obtained.

It can be seen that the Michelson interferometer includes a plurality of optical components, leading to a complex structure of the Fourier spectrometer that takes the Michelson interferometer as a core and difficulty in miniaturization. For example, in 2006, Stanford University in the United States and Seoul National University in South Korea collaborated to create a time-modulated micro Fourier spectrometer using LIGA technology (including photoetching, electroforming, and plastic injection molding). The interference system of this micro Fourier spectrometer has dimensions of 4 mm×8 mm×0.6 mm, a resolution of 50 nm, and a detection range of 1500 nm to 1590 nm. In 2008, the Mound Laboratory in the United States used Micro-Electro-Mechanical System (MEMS) technology to prepare a time-modulated micro infrared spectrometer with a detection range of 2-14 μm. However, this micro infrared spectrometer requires a high-precision moving mirror drive system, leading to difficulties in processing, assembly, and calibration. In recent years, researchers have also attempted to prepare micro Fourier spectrometers using an optical waveguide structure of Mach-Zehnder Interferometer (MZI). In 2020, Nature Photonics reported a method of using lithium niobate combined with electro-optic modulation to create a near-infrared spectrometer with a resolution of 5.5 nm, an operating bandwidth of 500 nm, and an area of only 10 mm². However, this near-infrared spectrometer has a limited operating bandwidth, which is constrained by the number of samples and materials, and additionally, it requires waveguide coupling for incident light, making it unsuitable for remote sensing detection. Moreover, the physical size of the aforementioned spectrometers is still relatively large and does not meet the demands for miniaturization.

The interference structure provided in the embodiments of the present disclosure is applied to a spectrometer, and the interference structure is configured to receive incident light and output a plurality of beams of interference light corresponding to the incident light. The interference structure includes: an interference film layer including a plurality of regions, where the plurality of regions includes a transparent region made of transparent material, and in a direction perpendicular to the interference film layer, a thickness of at least one region in the plurality of regions is different from a thickness of a region other than the at least one region in the plurality of regions. As for an interference structure of a traditional spectrometer, a beam of incident light is transformed into two beams of interference light through multiple optical lenses including a beam splitter, a phase compensation mirror, a moving mirror, a fixed mirror, and the like, so that the structure of the spectrometer is complex and miniaturization of the spectrometer is difficult. However, in the present disclosure, as the interference film layer includes the plurality of regions with different thicknesses, it is possible to transform the incident light into the plurality of beams of interference light corresponding to the incident light without multiple optical lenses in the traditional interference structure. Therefore, the structure of the interference structure provided by the present disclosure is simple and easy to miniaturize.

In addition, compared to the interference structure in traditional spectrometers, the interference structure of the present disclosure does not include moving parts (such as moving mirrors), therefore, the interference structure of the present disclosure has better stability and higher reliability. The traditional spectrometer relies on the moving part to scan and obtain the plurality of beams of interference light, thereby obtaining target spectral information. However, the spectrometer, including the interference structure of the present disclosure, can obtain the plurality of beams of interference light through the arrangement of the plurality of regions on the interference film layer, without the need for scanning. Only one shot is needed to obtain target spectral information, which improves the spectral reconstruction efficiency of the spectrometer.

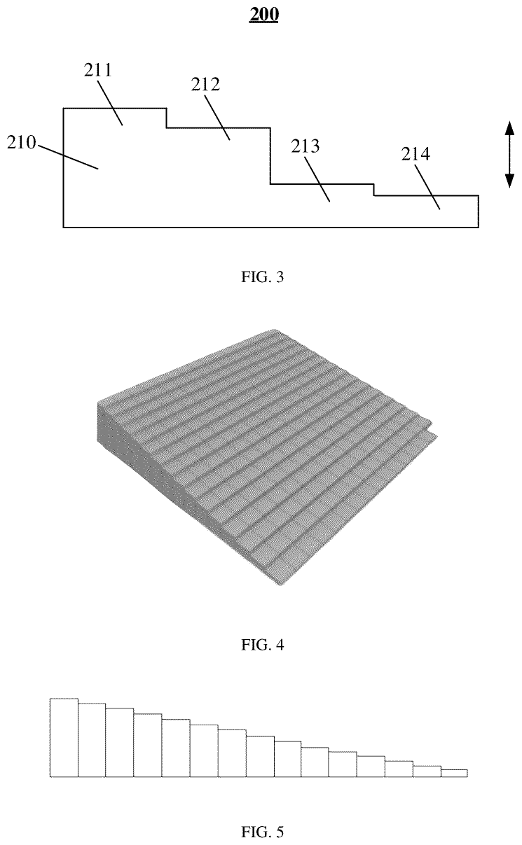

FIG. 2 is a schematic diagram of an interference structure according to an embodiment of the present disclosure. FIG. 3 is a schematic diagram of an interference structure according to another embodiment of the present disclosure. As shown in FIGS. 2 to 3, an interference structure 200 is applied to a spectrometer. The interference structure 200 is configured to receive incident light and output a plurality of beams of interference light corresponding to the incident light. The interference structure 200 includes an interference film layer 210. The interference film layer 210 includes a plurality of regions. Four regions are shown in FIG. 2, namely a first region 211, a second region 212, a third region 213, and a fourth region 214.

Specifically, in a direction perpendicular to the interference film layer 210 (that is, a direction indicated by an arrow in FIG. 2 or FIG. 3), a thickness of at least one region in the plurality of regions is different from a thickness of a region other than the at least one region in the plurality of regions.

Exemplarily, as shown in FIGS. 2 to 3, in the direction perpendicular to the interference film layer 210 (that is, the direction indicated by the arrow in FIG. 2 or FIG. 3), the thicknesses of the plurality of regions may all be different.

Specifically, the plurality of regions include a transparent region made of transparent material. In practical applications, each region may be made of the transparent material, that is, each region is a transparent region. In practical applications, a central part of each region may be made of the transparent material, and an edge part of each region may be made of other opaque materials. The transparent material may be one or more of SiO₂, SiO, Si, Ge, ZnS, BaF₂, CaF₂, MgF₂, InGaAs, GaAs, InP, BN, mica, Al₂O₃, diamond, SiC, and GaN. The transparent material may also be other transparent material, which is not limited in the present disclosure.

In some embodiments, the plurality of regions may include two regions, three regions, four regions, or more regions. FIG. 4 is a three-dimensional schematic diagram of an interference structure according to another embodiment of the present disclosure. FIG. 5 is a side view of the interference structure shown in FIG. 4. As shown in FIGS. 4 to 5, in practical applications, the plurality of regions may include hundreds of regions.

As the interference film includes the plurality of regions with different thicknesses, it is possible to transform the incident light into the plurality of beams of interference light corresponding to the incident light without multiple optical lenses in the traditional interference structure. Therefore, the structure of the interference structure in the present disclosure is simple and easy to miniaturize.

In addition, compared to the interference structure in traditional spectrometers, the interference structure of the present disclosure does not include moving parts (such as moving mirrors), therefore, the interference structure of the present disclosure has better stability and higher reliability. The traditional spectrometer relies on the moving part to scan and obtain the plurality of beams of interference light, thereby obtaining target spectral information. However, the spectrometer, including the interference structure of the present disclosure, can obtain the plurality of beams of interference light through the arrangement of the plurality of regions on the interference film layer, without the need for scanning. Only one shot is needed to obtain target spectral information, which improves the spectral reconstruction efficiency of the spectrometer.

In some embodiments, as shown in FIGS. 2 to 3, on a plane perpendicular to the interference film layer, a cross-section of the interference film layer includes a stepped shape, and each step of the stepped shape corresponds to one region in the plurality of regions. In practical applications, as the cross-section of the interference film layer includes the stepped shape, it is advantageous to control the thickness of each step of the stepped shape when preparing the interference film layer.

In some embodiments, as shown in FIG. 2, in the direction perpendicular to the interference film layer, each height difference between adjacent steps is the same, thereby improving noise resistance of the interference structure.

In some embodiments, as shown in FIG. 3, in the direction perpendicular to the interference film layer, a plurality of height differences between adjacent steps may be different. For example, a height difference between steps corresponding to the region 211 and the region 212 is different from a height difference between steps corresponding to the region 212 and the region 213.

In some embodiments, in the direction perpendicular to the interference film layer, a height difference between adjacent steps satisfies D≤1/(2×N×V), where D is the height difference, N is a refractive index of the transparent material, and V is a maximum wave number that the interference structure is capable of measuring.

According to interference transformation theory, the smaller the height difference between adjacent steps is, the more accurate the measurement results of the spectrometer including the interference structure is. Therefore, by making the height difference between adjacent steps satisfy D≤1/(2×N×V), the accuracy of the measurement results of the spectrometer including the interference structure is ensured.

In some embodiments, a thickness of the interference film layer ranges from 0 microns to 300 microns, further ensuring the accuracy of the measurement results of the spectrometer including the interference structure. A position where the thickness of the interference film layer is 0 microns represents a position of a hollow of the interference film layer, that is, the interference film layer is etched through at this position.

In some embodiments, the thickness of the interference film layer may also range within other numerical ranges. For example, the thickness of the interference film layer may be greater than 0 microns and less than 10 centimeters. A specific thickness range of the interference film layer may be determined according to actual requirement.

In some embodiments, on the plane perpendicular to the interference film layer, the cross-section of the interference film layer may also have other shapes.

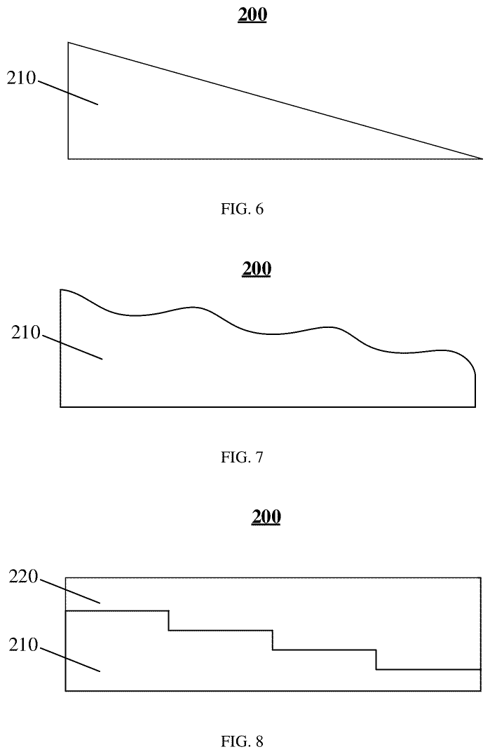

FIG. 6 is a schematic diagram of an interference structure according to another embodiment of the present disclosure. As shown in FIG. 6, on the plane perpendicular to the interference film layer, the cross-section of the interference film layer can be a wedge shape.

FIG. 7 is a schematic diagram of an interference structure according to still another embodiment of the present disclosure. As shown in FIG. 7, on the plane perpendicular to the interference film layer, a side surface of the interference film layer may be wavy.

According to the interference structures shown in FIGS. 6 to 7, by making the cross-section of the interference film layer wedge-shaped or making a side surface of the interference film layer wavy-shaped, in the direction perpendicular to the interference film layer, the thickness of at least one region in the plurality of regions is different from the thickness of the region other than the at least one region in the plurality of regions.

FIG. 8 is a schematic diagram of an interference structure according to yet still another embodiment of the present disclosure. As shown in FIG. 8, the interference structure 200 further includes a first transparent protection layer 220 stacked with the interference film layer 210.

Specifically, the material of the first transparent protection layer 220 may include one or more SiO₂, SiO, Si, Ge, ZnS, BaF₂, CaF₂, MgF₂, InGaAs, GaAs, InP, BN, mica, Al₂O₃, diamond, SiC, and GaN. The material of the first transparent protection layer 220 may also be other transparent material, which is not limited in the present disclosure.

By arranging the first transparent protection layer 220 stacked with the interference film layer 210 in the interference structure 200, it is possible to protect the interference film layer 210 from wear.

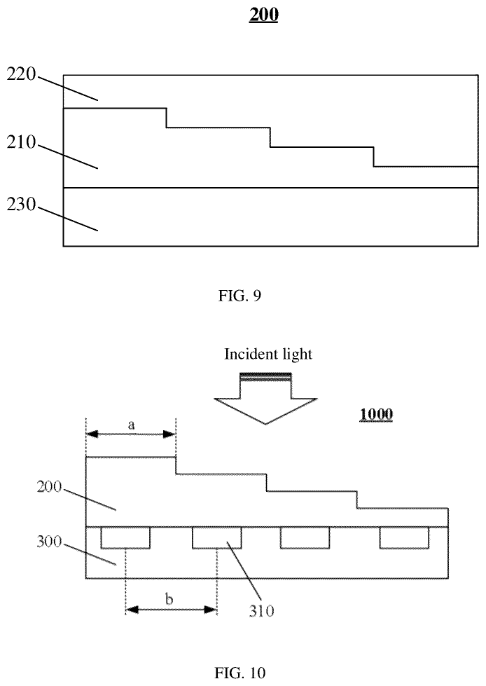

FIG. 9 is a schematic diagram of an interference structure according to yet still another embodiment of the present disclosure. As shown in FIG. 9, the interference structure 200 may further include a second transparent protection layer 230. The second transparent protection layer 230 is disposed on a side, away from the first transparent protection layer 220, of the interference film layer 210.

Specifically, a material of the second transparent protection layer 230 may include one or more of SiO₂, SiO, Si, Ge, ZnS, BaF₂, CaF₂, MgF₂, InGaAs, GaAs, InP, BN, mica, Al₂O₃, diamond, SiC, and GaN. The material of the second transparent protection layer 230 may also be other transparent material, which is not limited in the present disclosure.

By arranging the first transparent protection layer 220 and the second transparent protection layer 230 stacked with the interference film layer 210 in the interference structure 200, both sides of the interference film layer 210 are protected from wear.

FIG. 10 is a schematic diagram of a detection apparatus according to an embodiment of the present disclosure. FIG. 11 is a schematic diagram of a detection apparatus according to another embodiment of the present disclosure. As shown in FIGS. 10 and 11, the detection apparatus 1000 includes: an interference structure 200 and a detector 300.

Specifically, the detector 300 is stacked with the interference structure 200, and is configured to detect a plurality of beams of interference light output by the interference structure 200 and generate spectral response data corresponding to the plurality of beams of interference light.

Exemplarily, the detector 300 may be a focal plane detector. The focal plane detector may be any one of a Charge-coupled Device (CCD) detector, a Complementary Metal Oxide Semiconductor (CMOS) detector, a gallium indium arsenide (InGaAs) shortwave infrared detector, a thermal detector, a cadmium mercury telluride (HgCdTe) infrared detector, a type II superlattice infrared detector, and a quantum well infrared detector. The detector 300 may also be the other type of detector, which is not limited in the present disclosure.

Specifically, the detector 300 may include a plurality of pixels 310. Each step corresponds to at least one pixel 310. To ensure that each step corresponds to at least one pixel 310, a distance ‘a’ between canters of adjacent pixels 310 is less than a side length ‘b’ of each step.

In practical applications, as shown in FIG. 10, when an incident light enters the interference structure 200 vertically, a plurality of beams of interference light are output by the interference structure 200 and detected by the pixel 310.

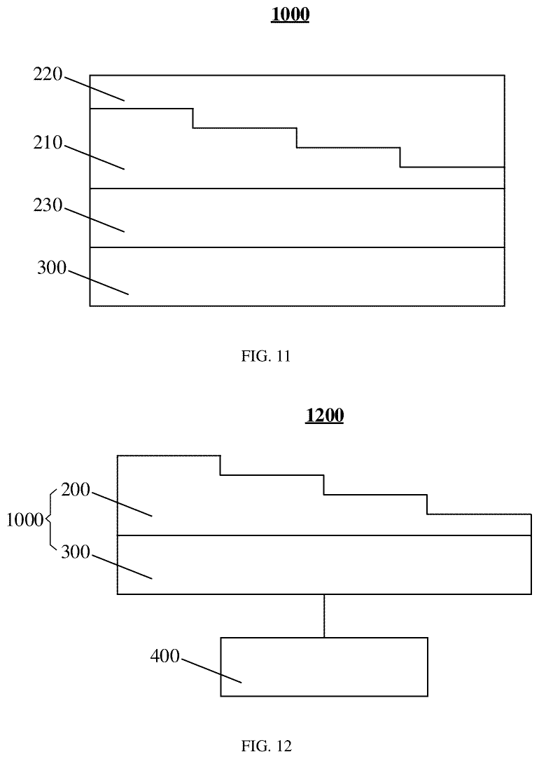

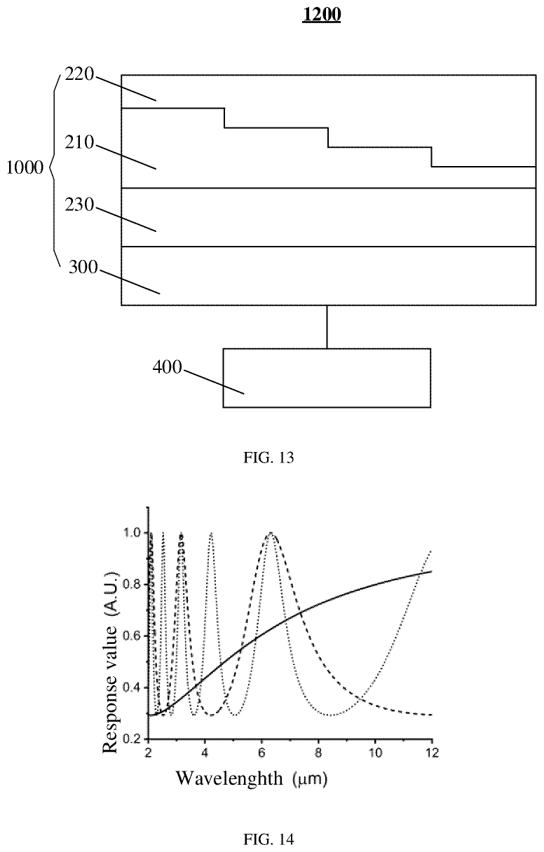

FIG. 12 is a schematic diagram of a spectrometer according to an embodiment of the present disclosure. FIG. 13 is a schematic diagram of a spectrometer according to another embodiment of the present disclosure. As shown in FIGS. 12 and 13, the spectrometer 1200 includes a detection apparatus 1000 and a processor 400. The processor 400 is connected to the detection apparatus 1000, and is configured to reconstruct spectral response data to generate reconstructed spectral data.

Specifically, the processor 400 is configured to execute a spectral reconstruction algorithm to reconstruct the spectral response data generated by the detection apparatus 1000, and generate reconstructed spectral data.

The spectral reconstruction algorithm may be one or a fusion of generalized inverse algorithm, least squares method, Tikhonov regularization algorithm, compressive sensing algorithm, machine learning algorithm, spectral feature-based (SR) reconstruction algorithm. The spectral reconstruction algorithm may also be other algorithms, which is not limited in the present disclosure.

According to embodiments of the present disclosure, a miniaturized interference structure is used to replace a beam splitter, a phase compensation mirror, a moving mirror, and a fixed mirror in an original Michelson interferometer. Meanwhile, a single optical path system is used to replace an original dual optical path system, allowing the interference structure to be directly integrated with a detector, so that a structure of the spectrometer 1200 may be simplified and miniaturized spectrometer 1200 may be obtained. The spectrometer 1200 of the present disclosure may be a miniature spectrometer or even a chip spectrometer, with a very small volume.

According to the present disclosure, the spectral reconstruction algorithm is combined with the spectral response data, so that a mode of dual beam interference may be innovated to a mode of multi-beam interference by the spectral reconstruction algorithm, thereby achieving a simple design of the present disclosure. In addition, as the spectral response data has good orthogonal characteristics, a basis with a low condition number is provided for the spectral reconstruction algorithm, thereby reducing noise interference.

The spectrometer 1200 provided by the present disclosure is capable of using interference spectra (that is, the spectral response data) to restore target spectral information (that is, the reconstructed spectral data). Compared with optical splitters such as rasters and Fabry Perot filters, spectral information of an entire wavelength band may be utilized by the interference structure 200. Thus, the interference structure 200 provided by the present disclosure has a higher luminous flux and higher efficiency in optical energy utilization.

In some embodiments, the spectrometer 1200 may be an infrared thin-film interferometric chip-level spectrometer. A wavelength detected by the infrared thin-film interferometric chip-level spectrometer ranges from 2 μm to 12.5 μm. An interference structure of the infrared thin-film interferometric chip-level spectrometer may include silicon steps with 30×30 channels (that is, an interference film layer of the interference structure includes 900 regions). Each step has an area of 30×30 μm², and a total area of all steps is 0.81 mm². A thickness of the interference film layer gradually increases from 0.147 μm to 139 μm, and each height difference between adjacent steps is 0.147 μm. The infrared thin-film interferometric chip-level spectrometer may be obtained by integrating the interference structure with a mid infrared focal plane cadmium telluride mercury detector (detection band ranges from 2 μm to 12.5 μm, pixel spacing is 30 μm). The steps of the interference film layer in the infrared thin-film interferometric chip-level spectrometer are in a one-to-one correspondence with the detector pixels.

FIG. 14 is a spectral response of a detector pixel. Specifically, FIG. 14 shows response values of the detector pixel to light of different wavelengths, where the unit of the wavelength is μm and the unit of response value is A.U. A large-scale Fourier spectrometer in the laboratory is used to calibrate the spectral response of each pixel of the interference micro spectrometer, and a response matrix of spectral response of all detector pixels is formed. The spectral response of some detector pixels modulated by regions corresponding to the steps are shown in FIG. 14.

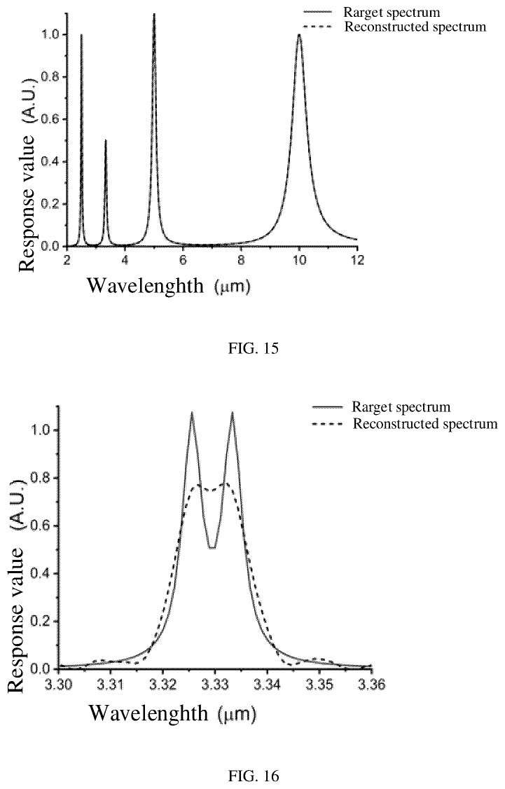

FIG. 15 is a reconstructed spectrum obtained by detecting a signal with four peaks using an infrared thin-film interferometric chip-level spectrometer. For ease of comparison, a target spectrum is also shown in FIG. 15. The infrared thin-film interferometric chip-level spectrometer is used to detect a signal with four peaks to extract response signal vectors of detector pixels. Then, a general inverse matrix algorithm is used to restore the target spectrum, so that the reconstructed spectrum shown in FIG. 15 is obtained.

FIG. 16 is a reconstructed spectrum obtained by calibrating the resolution of an infrared thin-film interferometric chip-level spectrometer using bimodal narrow light. For ease of comparison, a target spectrum is also shown in FIG. 16. The resolution of the infrared thin-film interferometric chip-level spectrometer was calibrated by using the bimodal narrow light. Then the target spectrum is reconstructed using a general inverse matrix algorithm to obtain the reconstructed spectrum shown in FIG. 16. It can be seen that a maximum resolution of the spectrometer is 7 cm⁻¹, that is, the resolution of the spectrometer at a wavelength of 3 μm is 12 nm.

As shown in FIGS. 14 to 16, the resolution of the spectrometer provided by the embodiments of the present disclosure is relatively higher.

The block diagrams of devices, apparatus, equipment, and systems involved in the present disclosure are provided as exemplary illustrations and do not intend to require or imply that connections, arrangements, or configurations must be made in the manner shown in the block diagrams. As those skilled in the art will recognize, these devices, apparatus, equipment, and systems can be connected, arranged, and configured in any manner. Words such as “comprising”, “including”, “having”, and the like are open-ended terms, meaning “including but not limited to”, and may be interchanged with each other. The terms “or” and “and” as used herein refer to the term “and/or”, and may be interchanged with each other, unless the context clearly indicates otherwise. The term “such as” as used herein refers to the phrase “such as but not limited to”, and may be interchanged with it.

It should also be pointed out that in the device, equipment, and method of the present disclosure, each component or step can be decomposed and/or recombined. These decompositions and/or recombinations should be considered as equivalent solutions of the present disclosure.

The above description of the aspects disclosed is provided to enable any person skilled in the art to make or use the present disclosure. Various modifications to these aspects will be readily apparent to those skilled in the art, and the general principles defined herein can be applied to other aspects without departing from the scope of the present disclosure. Therefore, the present disclosure is not intended to be limited to the aspects shown herein, but is to be given the broadest scope consistent with the principles and novel features disclosed herein.

The above descriptions have been provided for illustrative and descriptive purposes. Moreover, this description is not intended to limit the embodiments of the present disclosure to the forms disclosed herein. Although multiple exemplary aspects and embodiments have been discussed above, those skilled in the art will recognize that certain variations, modifications, alterations, additions, and sub-combinations are possible.

The above is merely a preferred embodiment of the present disclosure and is not intended to limit the scope of the application. Any modifications, equivalent substitutions, and the like that fall within the spirit and principles of the application should be included within the protection scope of the present disclosure.

What is claimed is:

1. An interference structure, applied to a spectrometer, wherein the interference structure is configured to receive incident light and output a plurality of beams of interference light corresponding to the incident light, and the interference structure comprises:
an interference film layer comprising a plurality of regions, wherein the plurality of regions comprises a transparent region made of transparent material, and
in a direction perpendicular to the interference film layer, a thickness of at least one region in the plurality of regions is different from a thickness of a region other than the at least one region in the plurality of regions.

2. The interference structure according to claim 1, wherein on a plane perpendicular to the interference film layer, a cross-section of the interference film layer comprises a stepped shape, and each step of the stepped shape corresponds to one region in the plurality of regions.

3. The interference structure according to claim 2, wherein in the direction perpendicular to the interference film layer, each height difference between adjacent steps is the same.

4. The interference structure according to claim 2, wherein in the direction perpendicular to the interference film layer, a plurality of height differences between adjacent steps are different.

5. The interference structure according to claim 2, wherein in the direction perpendicular to the interference film layer, a height difference between adjacent steps satisfies D≤1/(2×N×V), wherein
D is the height difference, N is a refractive index of the transparent material, and V is a maximum wave number that the interference structure is capable of measuring.

6. The interference structure according to claim 1, wherein on a plane perpendicular to the interference film layer, a cross-section of the interference film layer comprises a wedge shape.

7. The interference structure according to claim 1, wherein on a plane perpendicular to the interference film layer, a side surface of the interference film layer is wavy.

8. The interference structure according to claim 1, further comprising:
a first transparent protection layer stacked with the interference film layer.

9. The interference structure according to claim 8, further comprising:
a second transparent protection layer, disposed on a side, away from the first transparent protection layer, of the interference film layer.

10. The interference structure according to claim 1, wherein a thickness of the interference film layer ranges from 0 microns to 300 microns.

11. The interference structure according to claim 1, wherein the transparent material comprises one or more of SiO₂, SiO, Si, Ge, ZnS, BaF₂, CaF₂, MgF₂, InGaAs, GaAs, InP, BN, mica, Al₂O₃, diamond, SiC, and GaN.

12. A detection apparatus, comprising:
the interference structure according to claim 1; and
a detector stacked with the interference structure, configured to detect the plurality of beams of interference light output by the interference structure and generate spectral response data corresponding to the plurality of beams of interference light.

13. The detection apparatus according to claim 12, wherein the detector comprises any one of a charge coupled element detector, a complementary metal oxide semiconductor detector, a gallium indium arsenide shortwave infrared detector, a thermal detector, a cadmium telluride mercury infrared detector, a type II superlattice infrared detector, and a quantum well infrared detector.

14. A spectrometer, comprising:
the detection apparatus according to claim 12; and
a processor connected to the detection apparatus, configured to reconstruct the spectral response data to generate reconstructed spectral data.
